(19) United States
(12) Patent Application Publication
(10) Pub. No.: US 2022/0363597 A1
(43) Pub. Date: Nov. 17, 2022

(54) SYNTHETIC ALUMINOSILICATE MATERIAL AND METHODS OF FORMING AND USING SAME

(71) Applicant: The Regents of the University of Colorado, a body corporated, Denver, CO (US)

(72) Inventors: Wilfred V. Srubar, III, Boulder, CO (US); Juan Pablo Gevaudan, Austin, TX (US); Jacqueline D. Wallat-Pullara, Centennial, CO (US)

(73) Assignee: The Regents of the University of Colorado, a body corporated, Denver, CO (US)

(21) Appl. No.: 17/635,306

(22) PCT Filed: Aug. 11, 2020
(86) PCT No.: PCT/US2020/045804

§ 371 Date: Feb. 14, 2022

Related U.S. Application Data
(60) Provisional application No. 62/885,748, filed on Aug. 12, 2019.
(60) Provisional application No. 62/914,887, filed on Oct. 14, 2019.

(51) Int. Cl. C04B 12/00; C04B 28/00; C04B 22/06; C04B 22/10

(52) U.S. Cl. CPC C04B 12/005; C04B 28/006; C04B 22/062; C04B 22/10; C04B 2111/23

(57) ABSTRACT

Methods of forming synthetic aluminosilicate material are disclosed. Exemplary methods include forming a polymer solution, adding an aluminum precursor to the polymer solution, adding a silicon precursor to the polymer solution, forming a gel from the polymer solution, calcining the gel to form an aluminosilicate powder, and grinding the aluminosilicate powder to form ground aluminosilicate material. The synthetic aluminosilicate material can be used in the formation of cement and concrete.

### CROSS REFERENCE TO RELATED APPLICATIONS

This application claims the benefit of U.S. Provisional Application Ser. No. 62/885,748, filed on Aug. 12, 2019, and entitled Synthetic Aluminosilicate and of U.S. Provisional Application Ser. No. 62/914,887, filed on Oct. 14, 2019, and entitled Synthetic Aluminosilicate Material and Methods of Forming and Using Same.

### FIELD OF THE DISCLOSURE

The present disclosure generally relates to methods of forming synthetic aluminosilicate material. More particularly, examples of the disclosure relate to methods of forming aluminosilicate material using polymer solutions.

### BACKGROUND OF THE DISCLOSURE

Industrial byproducts, such as fly ash and slag, metakaolin, and calinated clay, are aluminosilicate powders that are used in the production of inorganic cements and as a supplement in Portland cement concrete. It is expected that the national and global supply of fly ash will be decreasing over the next 10-50 years due to the closing of coal-fired power plants. During this time, demand for these materials is expected to increase at a high rate.

Accordingly, new methods of forming aluminosilicate material are desired.

Any discussion of problems and solutions set forth in this section has been included in this disclosure solely for the purpose of providing a context for the present disclosure and should not be taken as an admission that any or all of the discussion was known at the time the invention was made.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

Various embodiments of the present disclosure relate to methods of forming an aluminosilicate material. The aluminosilicate material can be suitable for use in the production of inorganic cements and/or as a supplement in concrete. Additional embodiments of the disclosure relate to concrete or cement formed using the aluminosilicate material.

In accordance with exemplary embodiments of the disclosure, a method of forming aluminosilicate material includes forming a polymer solution, adding an aluminum precursor to the polymer solution, adding a silicon precursor to the polymer solution, forming a gel from the polymer solution, calcining the gel to form an aluminosilicate powder, and grinding the aluminosilicate powder to form ground aluminosilicate material. In accordance with examples of these embodiments, the step of forming a polymer solution comprises dissolving a polymer in water. By way of examples, a method can include dissolving polyethylene glycol (PEG), polyvinyl alcohol, or the like in water. An amount of polymer dissolved in water can be about greater than 0% to about 25%, about 0.1% to about 10%, or about 1% to about 5%. All percentages set forth herein are weight percentages, unless otherwise noted. A pH of the polymer solution can be about 1 to about 14 or about 1 to about 10. Exemplary methods can further include a step of passing the ground aluminosilicate material through a sieve, such as a 100 um mesh sieve. Exemplary methods can additionally or alternatively include a step of alkali activating the ground aluminosilicate material. A step of alkali activating the ground aluminosilicate material can include, for example, adding one or more of an NaOH solution, KOH solution, NaSi solution, Na₂CO₃ or the like solution to the ground aluminosilicate material. A concentration of the solution can be about 0.1M to about 15M, or about 0.1M to about 14M, or about 1M to about 10M alkali salt in solution. Exemplary methods can also include adding one or more additives to the polymer solution.

In accordance with further examples of the disclosure, a method can include a step of forming a cement using one or more aluminosilicate materials formed as described herein.

In accordance with additional examples of the disclosure, a method can include a step of forming a paste using one or more aluminosilicate materials formed as described herein.

In accordance with additional examples of the disclosure, a method can include a step of forming concrete (e.g., acid-resistant concrete) using one or more aluminosilicate materials formed as described herein.

In accordance with yet additional embodiments of the disclosure, concrete (e.g., acid-resistant concrete) including aluminosilicate material, as described herein, is provided.

These and other embodiments will become readily apparent to those skilled in the art from the following detailed description of certain embodiments having reference to the figures; the disclosure not being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates the process and nomenclature used in this disclosure.

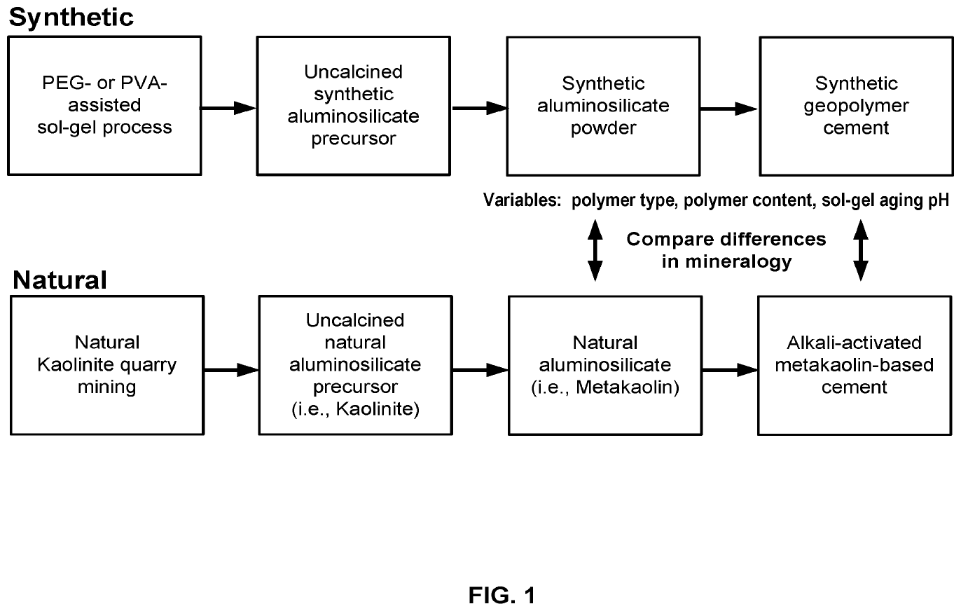

FIG. 2 illustrates chemical composition of all geopolymer cements synthesized from synthetic aluminosilicate precursors. Illustrated average values for Si:Al and Na:Al atomic ratios are 1.02±0.07 and 1.22±0.07, respectively.

FIG. 3 illustrates mineralogy for (a) synthetic aluminosilicate powders and (b) alkali-activated geopolymer cements. Symbols represent mineral formations as follows—A: γ-alumina (Al₂O₃, PDF#01-074-2206), ZA: Zeolite A (Al₂O₃SiO₂, PDF#00-038-0323), N: Sodium Carbonate (Na₂CO₃, PDF#01-072-0628).

FIG. 4 illustrates Fourier-Transform Infrared Spectroscopy of (a) uncalcined synthetic aluminosilicate precursors, (b) synthetic aluminosilicate powders, and (c) geopolymer cements.

FIG. 5 illustrates 29Si MAS-NMR and 1H-29Si MAS-NMR spectra for uncalcined synthetic aluminosilicate precursors (U), synthetic aluminosilicate powders (A), and geopolymer cements (C).

FIG. 6 illustrates 27Al MAS-NMR (a-c) and 1H-27Al MAS-NMR spectra for uncalcined synthetic aluminosilicate precursors (U), synthetic aluminosilicate powders (A), and geopolymer cements (C).

FIG. 7 illustrates mineralogy of metakaolin-based samples (Si:Al=1.0, Na:Al=1.1) with similar curing conditions and confirms similar mineralogy as PVA-derived geopolymer cements. ZA: Zeolite A (Al₂O₃SiO₂, PDF#00-038-0323), N: Sodium Carbonate (Na₂CO₃, PDF#01-072-0628), C: Corundum (Al₂O₃, internal standard).

FIG. 8 illustrates hypothesized mechanisms of polymer-assisted sol-gel synthesis: (i) ionic competition between polymer cross-linker coordination and silanol-based polycondensation; (ii) complexation with polymer cross-linker; (iii) hydrogen bonding with silanol group; and (iv) poor homogenization and phase segregation, as observed for PEG-derived calcined precursors.

FIG. 9 illustrates a method in accordance with examples of the disclosure.

FIG. 10 illustrates another method in accordance with examples of the disclosure.

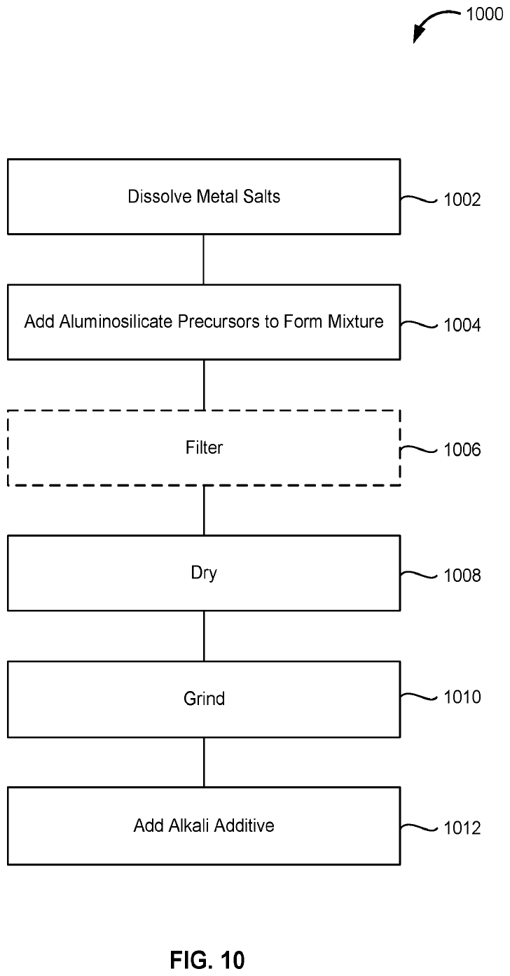

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

The present disclosure generally relates to methods of forming synthetic aluminosilicate material, to methods of forming other materials that include the synthetic aluminosilicate, and to concrete and other materials that include the synthetic aluminosilicate.

A synthetic aluminosilicate material (e.g., powder) may be used to make inorganic cements or as a supplement to, for example, Portland cement in concrete. The synthetic aluminosilicate powder can replace more conventional industrial byproduct materials that are used to make inorganic cements.

Synthetic aluminosilicate material as described herein can be created in such a way that it behaves, chemically speaking, identically (or substantially similar) to the natural and industrial byproduct aluminosilicates that are used today to form cement or concrete.

Polymer-assisted sol-gel synthesis—otherwise known as the organic steric entrapment (OSE) method—was first demonstrated in 1992 as a viable method to produce metal-oxide ceramics. Earlier, in 1931, conventional (i.e., non-polymer-assisted) sol-gel synthesis methods were used to produce ceramics using alkoxysilanes. The primary aim of sol-gel synthesis is typically to produce solid ceramics from a solution of liquid metal precursors via hydrolysis and subsequent polycondensation into a gel. By forming gels in a solution state, sol-gel synthesis methods facilitate atomic-level mixing, thereby circumventing challenges otherwise associated with solid-state chemistry (e.g., inhomogeneity, phase separation, low yield reactions). As a departure from conventional sol-gel synthesis, polymer-assisted sol-gel synthesis was first reported in a study that used polyethylene glycol (PEG) to synthesize nanocrystalline Perovskite materials. Soon thereafter, polyvinyl alcohol (PVA) was used to produce fine ferrite powders and mixed-metal-oxide materials. In 1999, polymer-assisted sol-gel synthesis was renamed the OSE method, due to the speculation that weak hydrog [symbol] polymer and metal oxides was primarily responsible for sterically entrapping and structuring solvated cations in solution.

As set forth herein, OSE can be used to synthesize metal-oxide precursors for use as traditional ordinary Portland cement (OPC) cementitious binders, as well as alternative cementitious binders such as calcium- and sodium-stabilized aluminosilicate hydrates (i.e., C-N-A-S-H and N-A-S-H). Examples of synthesized OPC phases/precursors include calcium aluminate, dicalcium silicate, tricalcium silicate, tricalcium aluminate, and tetracalcium aluminate iron oxide. These synthesized cementitious components can be pure, nano- or sub-micron sized, and highly reactive. Furthermore, alternative cementitious binders (e.g., calcium aluminosilicate hydrates and sodium aluminosilicate binders) can be formed using techniques described herein. Production of alternative cementitious binders through OSE presents a unique opportunity to understand the atomic structure and material properties by stoichiometric control of the alternative cement chemistry. Despite advances in polymer-assisted sol-gel synthesis, heretofore, the effect of processing conditions to produce aluminosilicate precursors that yield structural variants of N-A-S-H cementitious binders was not well understood. N-A-S-H cementitious binders, or geopolymer cements, have gained popularity for their controllable chemistry and potential for increased durability, improved fire resistance, and reduced environmental impacts compared to OPC in some applications. Traditionally, geopolymer materials are composed of N-A-S-H binders, which have a standard composition of SiO₂/Al₂O₃=3.3, Na₂O/Al₂O₃=1.1, and H₂O:Na₂O=11, with modern N-A-S-H binders having SiO₂/Al₂O₃ between 0.5 and 2.0 given the choice of low calcium precursor used. Multiple studies have been pivotal to understand the atomic structure and properties of N-A-S-H binders. However, little scientific understanding on process-structure effects of different N-A-S-H precursor synthesis conditions currently exists.

Process-structure relationships of synthetic aluminosilicate powders produced via polymer-assisted sol-gel synthesis, as well as process-structure relationships of resultant sodium-stabilized aluminum-silicate-hydrate (N-A-S-H) geopolymer cements are described herein. The influence of synthesis processing factors (i.e., polymer architecture, polymer content, and sol-gel aging pH) were explored using a 2² factorial design to reveal changes in atomic structure and variations in mineralogy in both synthetic aluminosilicate powders and resultant geopolymer cements. The mineralogy of geopolymer cements is also compared to that of alkali-activated metakaolin-based cements.

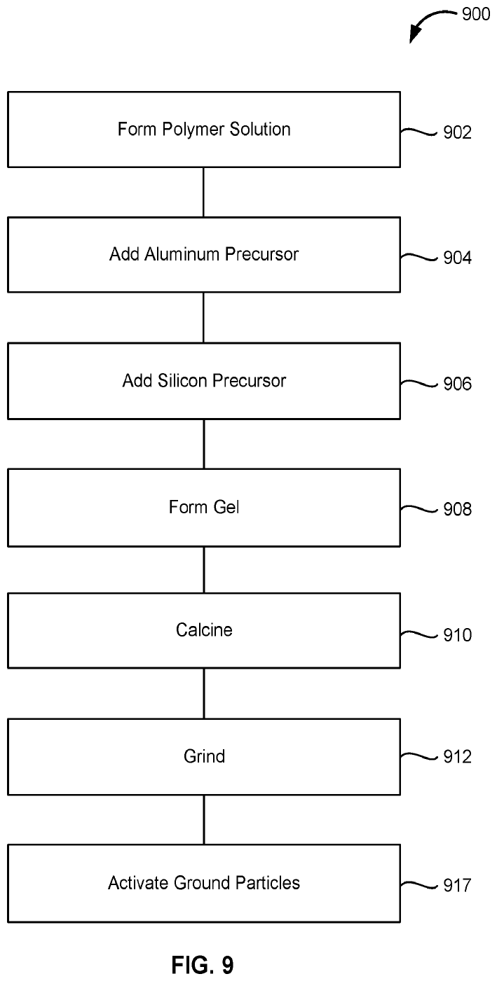

In accordance with various examples of the disclosure, a sol gel process is used to form (synthetic) aluminosilicate material. FIG. 9 illustrates an exemplary method 900 in accordance with examples of the disclosure. Method 900 includes the steps of forming a polymer solution (e.g., by dissolving a polymer, such as PEG and/or PVA, in a solvent, such as water) (step 902), adding an aluminum precursor (e.g., aluminum nitrite, aluminum hydroxide) to the polymer solution (step 904), adding a silicon precursor (e.g., colloidal silica, rice husk ash, or the like) to the polymer solution (step 906) (and dissolving the aluminum and silicon sources), forming a gel from the polymer solution (e.g., using sol gel techniques) (step 908), calcining (e.g., at a temperature of about up to 1200° C. or about 600° C. to about 900° C.) the gel to form an aluminosilicate powder (step 910), grinding the aluminosilicate powder to form ground aluminosilicate material (step 912), and activating the ground particles (step 914).

During step 902, a polymer can be dissolved in a solvent. An amount of polymer (e.g., PVA and/or PEG) dissolved in the solvent (e.g., water) can be about greater than 0% to about 25%, about 0.1% to about 10%, or about 1% to about 5%. A molecular weight of the PVA, PEG, and/or other suitable polymer (e.g., having one or more alcohol (e.g., end) groups and/or one or more acetate groups) can range from about 1 to about 500, about 10 to about 100, or about 30 to about 50 Da. A temperature of the solution can be about 20 to about 90° C.

During step 904, the aluminum precursor is added to the solution. Aluminum can be added in ranges from about 1% to 100% or about 40% to 60% to by weight of solution.

Silicon precursor is then added to the solution and the silicon precursor is allowed to dissolve during step 906. A temperature of the solution during step 906 can be about 20 to about 90° C. Various additives, such as zeolites, alkali salts (e.g., magnesium hydroxide), and/or activated carbon, can be added to the polymer solution during step 902-906.

During step 908, the gelling process can occur by a reduction in temperature—e.g., from about 100° C. to about 20° C. The gel can then be dried to form a foamy mass prior to calcining.

During calcining (step 910), a phase change in the aluminosilicate material can occur. The calcined material can be ground to a desired size—e.g., less than 100 μm or about 50 μm to about 100 μm—during step 912. The ground particles can be activated (step 914) by adding an alkali or basic solution or material to the ground aluminosilicate material. For example, about 0.1M to about 15M, or about 0.1M to about 14M, or about 1M to about 10M basic or alkali solution (e.g., a solution comprising one or more of an NaOH solution, KOH solution, NaSi solution, or Na₂CO₃) can be added to the ground aluminosilicate material. A cement can be formed from the alkali activated ground aluminosilicate material. And, concrete can be formed using the cement. Or, a coating can be formed using the alkali activated ground aluminosilicate material. The coating can be applied to, for example, concrete.

In accordance with exemplary embodiments of the disclosure, an acid-resistant composite material is provided. The acid-resistant composite material can include a synthetic aluminosilicate material as described herein. Exemplary acid-resistant composite materials can include greater than 0% to about 75% or about 40% to about 60% SiO₂; greater than 0% to about 75% or about 30% to about 50% Al₂O₃; about 1% to about 25% or about 1% to about 20% CaO; and greater than 0% to about 25%, or about 0.1% to about 10%, or about 1% to about 10% one or more monovalent, divalent, or polyvalent cationic metals. The one or more monovalent, divalent, or polyvalent cationic metals can include one or more group 2 and/or one or more transition metals. For example, the one or more monovalent, divalent, or polyvalent cationic metals can be selected from one or more group 2 and/or group 8-11 metals. By way of particular examples, one or more monovalent, divalent, or polyvalent cationic metals be selected from the group consisting of titanium, lithium, chromium, calcium copper, cobalt, iron, and magnesium. The acid-resistant composite material can include a plurality of the one or more monovalent, divalent, or polyvalent cationic metals. In accordance with various aspects of these embodiments, a ratio of silicon to aluminum in the acid-resistant composite material can be about 0.75 to about 3.0 or about 1.0 to about 2.5 or about 1.5 to about 2.0. A ratio of sodium to aluminum in the acid-resistant composite material can be about 1.0, or about 0.9 to about 1.1, or about 0.5 to about 1.5. In accordance with further examples of the disclosure, the one or more aluminosilicate precursors comprise a synthetic aluminosilicate precursor—e.g., formed using a method as described herein.

In accordance with further embodiments of the disclosure, a method of forming an acid-resistant composite material 1000 is provided. Method 1000 includes the steps of dissolving one or more alkaline metal salts in a solution (step 1002) and adding the solution to one or more aluminosilicate precursors and optionally other minerals to form a mixture (step 1004). The one or more aluminosilicate precursors comprise one or more of a synthetic aluminosilicate precursor, Metakaolin, fly ash, slag, pumice, basalt, glass, or other natural pozzolan. The method can optionally include filtering the mixture (step 1006). The method can also include a step of drying the mixture to form a dried material (step 1008). The drying can be performed using an oven or left to dry in ambient conditions. The dried material can be ground using a step of grinding (step 1010). The grinding can be performed using a mortar and pestle or an industrial grinder, which can also be used for step 912. Exemplary methods can further include adding an alkali additive to one or more of the mixture and the dried mixture (step 1012). The alkali additive can include, for example, one of more of sodium silicate, sodium hydroxide, potassium hydroxide, or sodium carbonate. The step of adding an alkali additive to one or more of the mixture and the dried material comprises adding a solid and/or a liquid. The alkali additive can include one or more of an NaOH solution, KOH solution, NaSi solution, Na₂CO₃. When in liquid form, a concentration of the solution can be about 0.1M to about 15M, or about 0.1M to about 14M, or about 1M to about 10M alkali salt in solution.

### Specific Examples

The examples provided below are merely exemplary and are not meant to limit the scope of the disclosure or invention described herein. Further, any values (e.g., temperature, times, percentages, molecular weights, sieve size, and the like) set forth below can be ±10 percent, ±5 percent, or ±2 percent of the stated values, unless noted otherwise.

### Materials

Polyvinyl alcohol (PVA) and polyethylene glycol (PEG) polymers of molecular weight 31-50 kDa (Mw) and 35 kDa (Mn), respectively, were obtained from MilliporeSigma. Aluminum nitrate nonahydrate (99+%, analysis grade, Acros Organics), a 40% by weight colloidal silica suspension (LUDOX TM-40, Millipore), sodium hydroxide (NaOH) (10M, BioUltra grade, MilliporeSigma), and NaOH (reagent grade) were also acquired from MilliporeSigma. Metakaolin (Si:Al=1.0) was supplied by BASF Chemical Corporation (MetaMax).

### Experimental Methods

### 2² Factorial Design

The influence of both polymer architecture and sol-gel aging pH was investigated using a 2² factorial design of experiments. Additionally, the influence of polymer content was explored in combination with the aforementioned factors. In terms of polymer architecture, both PEG and PVA of similar molecular weights were used to elucidate the role of polymer architecture. Sol-gel aging at two different pH conditions (low pH ˜1.0, high pH ˜10) explored pH-dependent metal-polymer interactions. Polymer content was explored by varying the ion-to-polymer-oxide atomic ratios (I/O) in two levels (see supplementary information for calculation of I/O). The “ion” content refers to aluminum metal ions, while the oxide solely refers to the polymer oxide content. The aluminum content of aluminum nitrate nonahydrate salts was determined to be 9.28 wt. % via ICP-OES and used to calculate accurate I/O ratios. As seen in Table 1, PVA-derived precursors had I/O ratios of 4.0 (low) and 5.2 (high), while PEG-derived precursors had I/O ratios of 3.7 (low) and 4.4 (high). While similar ratios have been described as metal-to-hydroxide (M/OH) atomic ratios, in the present disclosure, PVA chain hydroxyls are compared to PEG chain ethers and, as a result, a redefinition of this atomic ratio was used to account for the differences in polymer architecture as an I/O ratio, where oxide (O) accounts for ethers or hydroxyls.

### Polymer-Assisted Sol-Gel Synthesis and Characterization of Aluminosilicate Precursors

Aluminosilicate precursors were synthesized using a polymer-assisted sol-gel procedure—e.g., as described in connection with FIG. 9. The effect of polymer content (I/O ratio) as well as sol-gel aging pH condition were characterized. PEG and PVA polymeric solutions of 5% (by weight) were produced by incrementally adding the polymer to deionized water over heat (˜90° C.). Once the polymer was completely dissolved, verified by visual inspection, the solutions were left to age for one hour at a temperature of 60 to 70° C. Synthesis pH during sol-gel aging was controlled at two conditions, either low pH (˜1.0) or high pH (˜10.0), via order of reactant addition. For example, high-pH samples were synthesized by first adding the colloidal silica suspension reactant and allowing the polymer to interact with the reactant for one hour (sol-gel aging time) at a pH ˜10 (sol-gel aging condition). After one hour of sol-polymer interactions at high pH, a 40% (by weight) solution of aluminum nitrate nonahydrate solution was added, which decreased the pH to ˜1.0. For low-pH samples, addition of the aluminum nitrate nonahydrate solution was performed first and left to interact with the polymer for one hour before addition of the colloidal silica solution. The sol-gel synthesis conditions remained at a pH of ˜1.0. After the sol-gel aging process occurred, all solutions were dried via continuous stirring over heat (70 to 80° C.), during which a viscous and porous xerogel was formed. Samples of the xerogels (i.e., uncalcined synthetic aluminosilicate powders) were collected for subsequent characterization.

### Surface Area Characterization of Aluminosilicate Precursors

Both PVA and PEG xerogels were calcined at 550° C. and at 900° C., respectively, with a hold time of one hour (ramp rate of 3° C./minute). The resultant white material was ground to form a powder and sieved through a No. 100 sieve. Samples of the synthetic aluminosilicate powders were saved for subsequent characterization. The Brunauer-Emmett-Teller (BET) nitrogen adsorption method was used to measure the surface area of the calcined powders. Samples were massed and degassed under vacuum in an inert nitrogen atmosphere at 100° C. for at least eight hours. After conducting a blank acquisition, samples were placed into the instrument and nitrogen gas was deposited atop the powder surface by varying the N₂ pressure. For the measurement, eleven data points were collected with relative pressure (P/Po) ranging from 0.05 to 0.30 with a five second equilibration time. From the data, a BET plot was generated using a linear regression with a correlation coefficient of 0.99 for all data generated. The surface area of the resulting powders is reported in Table 1.

TABLE 1
Processing parameters and corresponding surface area (m²/g) of
synthesized aluminosilicate powders with 2SiO₂•Al₂O₃ stoichiometry.

| | Polymer | | | | | |
|---|---|---|---|---|---|---|
| | Molecular | Aging | | Polymer | | BET |
| | Weight | condition | | Content | | surface area |
| Sample | (kDa) | (pH) | | (I/O ratio) | | (m²/g) |
| PVA-L | 31-50 | ~1.0 | (Low) | 4.0 | (Low) | 127.3 ± 0.2 |
| | 31-50 | ~1.0 | (Low) | 5.2 | (High) | 121.4 ± 0.3 |
| PVA-H | 31-50 | ~10.0 | (High) | 4.0 | (Low) | 107.9 ± 0.9 |
| | 31-50 | ~10.0 | (High) | 5.2 | (High) | 130.8 ± 0.3 |
| PEG-L | 35 | ~1.0 | (Low) | 3.7 | (Low) | 129.6 ± 0.6 |
| | 31-50 | ~10.0 | (High) | | | |
| PEG-H | 35 | ~10.0 | (High) | 3.7 | (Low) | 141.9 ± 0.9 |
| | 35 | ~10.0 | (High) | 4.4 | (High) | 121.7 ± 0.5 |

### Geopolymerization of Synthetic and Natural Precursors

Aluminosilicate powders were alkali-activated via addition of NaOH (10M, BioUltra grade, MilliporeSigma) at a liquid-to-solid weight ratio of 0.75 to form synthetic geopolymer cements. Geopolymers were produced by manual mixing for one minute until a homogenous paste was obtained. Additionally, natural metakaolin-based geopolymer cements were utilized for mineralogical comparison. The mixing procedure included an initial one minute of manual mixing, followed by one minute of mechanical mixing using a Waring PDM112 mixer and one minute of additional manual mixing.

The natural metakaolin-based geopolymer cements were designed to exhibit equal chemical parameters as the synthetic geopolymer cements. More specifically, NaOH (reagent grade) was dissolved in deionized water to create activating solutions and yield Si:Al and Na:Al ratios of metakaolin-based geopolymer cements of 1.0 and 1.1, respectively. Both natural and synthetic geopolymer cements were cast in cylindrical molds (diameter: 1.26 cm, height: 3 cm) and cured at 35±5° C. and 100% relative humidity for 48±4 hours in a Quincy forced-air laboratory oven. Subsequently, samples were dried at 30° C. overnight (>12 hours).

### ²⁹Si and ²⁷Al Solid-State Magic Angle Spinning Nuclear Magnetic Resonance (MAS-NMR)

Solid-state ²⁹Si and ²⁷Al MAS-NMR spectra were acquired using a Varian INOVA 400 MHz NMR spectrometer (magnetic field 9.39 T; operating frequency of 79.50 MHz for ²⁹Si and 104.27 MHz for ²⁷Al). Samples were packed into 4 mm zirconia rotors sealed at either end with Teflon end plugs, and all spectra were collected with magic-angle spinning (MAS) speed of 10 kHz using a broadband probe equipped with a 4 mm MAS spinning module designed and manufactured by Revolution NMR, LLC (Fort Collins, Colo.). ²⁹Si chemical shifts were determined using the NMR signal from DSS (2,2-dimethyl- 2-silapentanesulfonate) referenced at 1.46 ppm. The spectra were acquired through a Bloch-decay experiment with 1600 scans using a pulse recycle delay of 5 s, a pulse width of 4.5 μs, and an acquisition time of ˜20 ms. These experimental parameters are sufficient for the qualitative analysis of the data, as presented herein. Cross-polarization (CP) MAS data were also collected using ¹H and ²⁹Si 90° pulse widths of 3.8 and 4.5 μs, respectively, with recycle delay of 2 s, CP spin-lock time of 3 ms, and 1600 scans. The ²⁷Al chemical shifts were referenced to aluminum nitrate (0.0 ppm) and the Bloch-decay experiment was acquired using a pulse recycle delay of 5 s, a pulse width of 4.5 μs, an acquisition time of ˜20 ms, and 256 scans. For cross-polarization (¹H—²⁷Al CP) MAS experiments, ¹H and ¹³C 90° pulse widths of 3.8 and 4.5 μs, respectively, were used with a recycle delay of 2 s, CP spin-lock time of 2 ms, and 256 scans. Peak identification and data processing was performed using MestReNova software.

### Inductively Coupled Plasma Optical Emission Spectrometry (ICP-OES)

Chemical characterization was determined with an ICP-OES (ARL 3410+) using an adapted protocol from a widely accepted technique developed by Farrell et al.

Five mL of a 7:3 mixture of hydrochloric acid and hydrofluoric acid were combined with 2 mL of nitric acid and placed in digestion tubes that were maintained at 95° C. in a digestion block (HotBlock by Environmental Express) for approximately two hours. Samples were then cooled and brought to 50 mL with a 1.5% boric acid solution (by mass). The samples were then reheated to 95° C. for 15 minutes and cooled for analysis. The samples were diluted 10× with deionized water and analyzed with an ICP-OES, as described above. An analytical blank, along with three standards that were made by accurately diluting certified standards, was used fc [symbol] basaltic internal standard (Valmont Dike, Colo., , USA) of known chemical composition was digested and analyzed to ensure accuracy of the results.

### Fourier Transform Infrared Spectroscopy (FTIR)

Samples for analysis were ground in a slurry of ethanol using a McCrone micronizing mill with yttrium-stabilized zirconium (American Elements) grinding beads for five minutes to ensure particle sizes <5 μm. Collected slurries were dried overnight at 60° C. Next, 0.02±0.005 grams of each sample were mixed with 2.00±0.050 grams of potassium bromide (KBr) powder (dried at 70° C. overnight). Then, the powder mixtures were homogenized in a Spex Grinder mill and pressed into KBr disk pellets for analysis in a Thermo Scientific Nicolet iS10 FTIR Spectrometer. As a result, KBr disks with sample concentrations of 1% (by weight) were produced. Disks were analyzed against a blank background to remove the absorption spectra from the chamber purged with nitrogen.

### X-ray Diffraction (XRD)

To determine the mineralogy of (1) calcined precursors and (2) both synthetic and natural alkali-activated geopolymer binders, samples were first crushed into a powder with a mortar and pestle. The calcined precursor and synthetic geopolymer binder powders were well packed in XRD sample holders. Metakaolin-based geopolymer binders were prepared for mineral analysis using a modified method based on Eberl (2003). The former method was modified to employ corundum as an internal standard instead of zincite. All samples were analyzed in a Siemens D500 X-ray diffractometer to acquire X-Ray diffraction patterns for all samples. Samples were analyzed from 5 to 65 degrees 20 using Cu Ka X-ray radiation, with a step size of 0.02 degrees and a dwell time of two seconds per step. Mineralogy was identified using Jade software (MDI, Version 9) and the International Centre for Diffraction Data (ICDD) 2003 database.

### Experimental Results and Analysis

### Stoichiometry of Geopolymer Cements

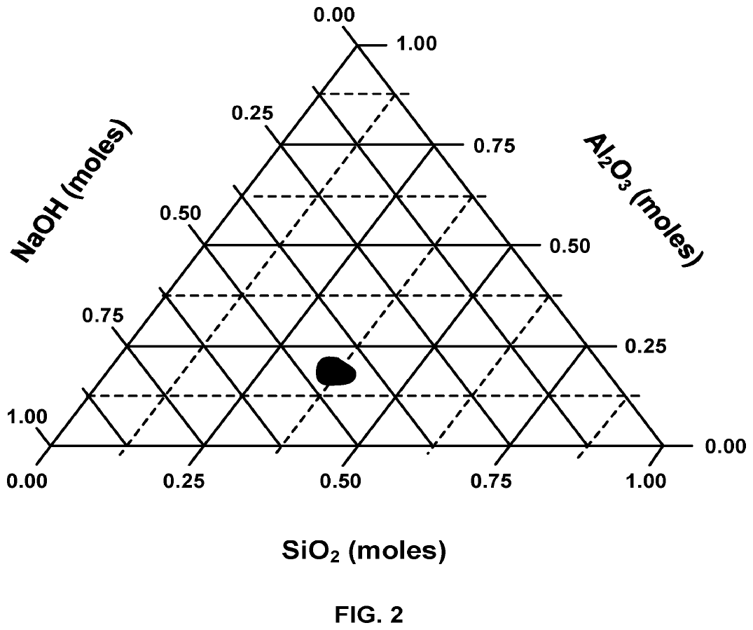

Synthesized geopolymer cements herein have substantially uniform chemical formulations of Na_{1.22}Si_{1.02}Al.xH₂O, see FIG. 2. As a result, the stoichiometry of geopolymer cements yields Si:Al and Na:Al atomic ratios of 1.02±0.07 and 1.22±0.07, respectively, regardless of polymer cross-linking agents (PEG and PVA), synthesis pH conditions (low and high) or I/O ratios (low and high). This chemical composition is similar to the theoretical design composition outlined above and bears important differences from “traditional” geopolymer materials, which are reported to have a standard composition of Si:Al=1.65 and Na:Al=1. As a result, important morphological differences exist due to their “non-traditional” cement chemistry. For example, the presence of mineral phases, such as zeolites, is expected at low silicon and high sodium contents when these samples are subjected to hydrothermal curing conditions.

### Mineralogy of Aluminosilicate Powders and Geopolymer Cements

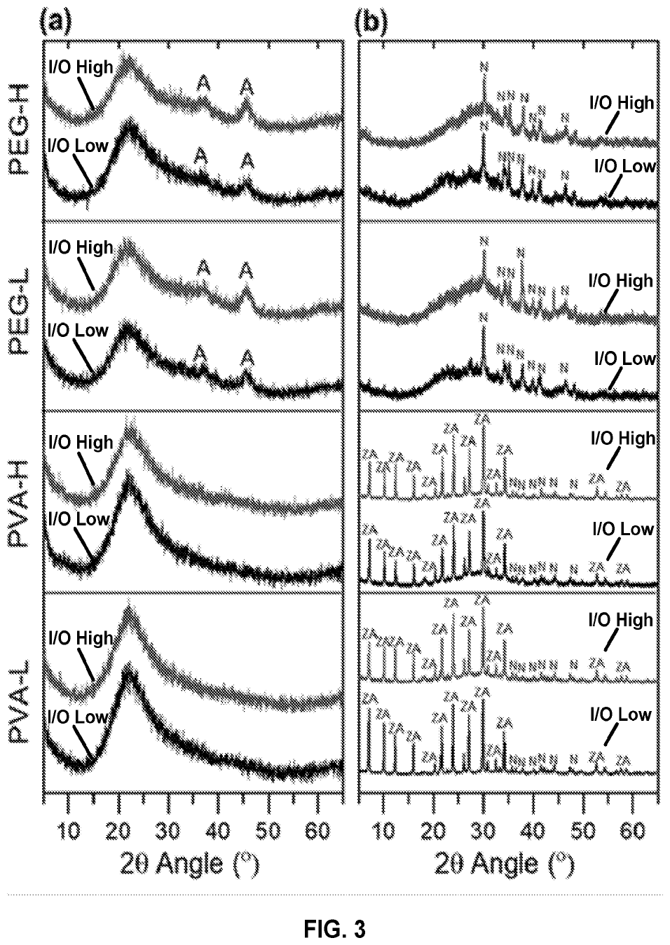

Regardless of synthesis pH and I/O ratio, mineralogical differences were only observed in samples produced with different polymers, as illustrated in FIG. 3. PVA-derived synthetic aluminosilicate powders demonstrate an amorphous curve at 23° 2θ angles and, after alkali activation, the geopolymer cements result in the formation of zeolite-A and sodium carbonate. Contrastingly, PEG-derived synthetic aluminosilicate powders demonstrate the formation of alumina phases, in addition to the aforementioned amorphous curve at 23° 2θ angles. After alkali activation, PEG-derived geopolymer cements result in the formation of sodium carbonate (e.g., solely) and no alumina phases diffraction patterns are observed, hence evidencing phase segregation, an undesirable product of inhomogeneity during reaction, as a result of the presence of ethers (i.e., C—O) in the PEG polymer cross-linker, which likely do not coordinate Al⁺³ ions as effectively as hydroxyl groups (i.e., O—H) of PVA polymers. Only synthetic aluminosilicate powders derived from PEG polymer cross-linkers result in the formation of alumina phases, as indicated by XRD (FIG. 3). Given the high-temperature calcination (i.e., 900° C.) for PEG-derived synthetic aluminosilicate powders, the alumina phase in FIG. 3 likely is that of γ-alumina. This alumina mineral forms due to dehydration between 500° C. and ˜900° C., as well as temperatures of up to 1200° C., and has a similar diffraction pattern as η-alumina.

### FTIR of Synthetic Precursors, Aluminosilicate Powders, and Geopolymer Cements

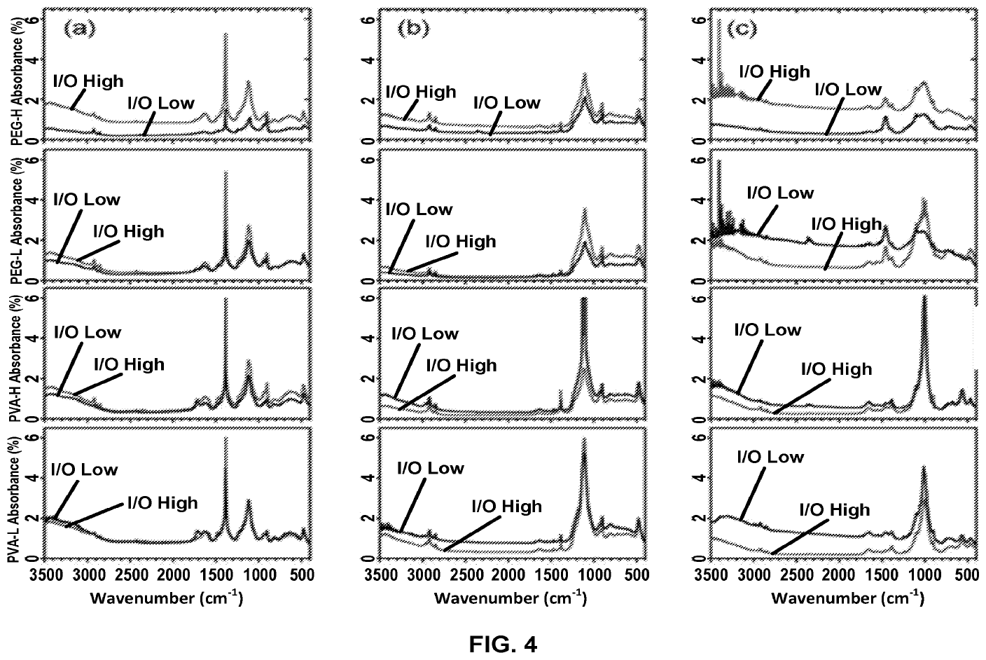

To probe the molecular structure of all synthesized materials, Fourier-transform infrared spectroscopy (FTIR) was undertaken. FTIR was collected for each of the samples throughout the reaction (FIG. 4) and compared to reagent materials.

In agreement with XRD diffractograms (FIG. 3), carbonation is evident in the FTIR spectra by a large vibrational peak at 1470 cm⁻¹ corresponding to O—C—O stretching of carbonate, which appears mainly for PEG-derived geopolymer cements as indicated by FIG. 4 and Table 2.

For PVA-derived uncalcined synthetic aluminosilicate precursors, regardless of pH or I/O, vibrational energy bands are observed with relatively the same peak location and peak intensity (FIG. 4). Key vibrational bands for PVA-derived products throughout the reaction are listed in Table 2. When compared to the uncalcined synthetic aluminosilicate precursor, the synthetic aluminosilicate powders show a (1) decrease of O—H, C—O, and C—H bond vibrational stretching (3500-3000 cm⁻¹, 2925 cm⁻¹, 2850 cm⁻¹, 1730 cm⁻¹ and 1645 cm⁻¹); (2) minor changes to the presence of N—O or O—C—O bond asymmetric stretching (1475cm⁻¹ and 1380 cm⁻¹); and (3) presence of Al—O and Si—O—Si bonds (1116 cm⁻¹, 904 cm⁻¹, 932 cm⁻¹, 722-540 cm⁻¹ and 480 cm⁻¹). Upon alkali activation, there are a number of key differences in the vibrational energy bands of the resulting materials, (1) the emergence of O—C—O and O—H vibrations due to carbonation and hydration of the cementitious material (1651 cm⁻¹, 1550 cm⁻¹, 1475 cm⁻¹ and 1380 cm⁻¹); (2) external linkage of SiO₄ and AlO₄ tetrahedral (560 cm⁻¹); and moreover, (3) aluminosilicate network formation (Si—O—Al) signified by a shift in frequency of peak toward 1000 cm⁻¹, which have traditionally been attributed to geopolymer formation or zeolite formation from aluminosilicate precursors (Table 2). In addition, absorption shoulders at 1116 cm⁻¹ and 908 cm⁻¹ are also identified in geopolymer cements, which indicate asymmetric Si—O stretching and were also observed in synthetic aluminosilicate powders. Such geopolymer network formation as well as external linkage vibration of Si—O₄ or Al—O₄, typical for zeolites, are also verified by XRD results, shown in FIG. 3, Table 2. Analysis of infrared vibrational bands in PVA derived products, (br) broad, (s) sharp, weak (w), and (sh) shoulder.

TABLE 2
Infrared vibrational bands in PVA derived products.

| (a) Uncalcined | (b) Calcined | (c) Geopolymer | |
|---|---|---|---|
| Precursor (cm⁻¹) | Precursor (cm⁻¹) | Cement (cm⁻¹) | Assignment |
| 3500-3000 (br) | Decrease intensity | Increase intensity | O—H vibrational |
| | compared to (a) | compared to (b) | stretching |
| 2925 (w) | Decrease intensity | Decrease intensity | C—H asymmetric |
| 2850 (sh) | compared to (a) | compared to (a) (b) | and symmetric |
| | | | stretching |
| 1730 (w)(sh) | No peak at 1730 or | Peak at 1650 same | C—O stretching and |
| 1650 (w) | 1645, new peak at 1670 | intensity as (b) | O—H stretching |
| 1450 (sh) | Decrease intensity | Same intensity | N—O stretching or |
| 1380 (s)(br) | compared to (a) | compared to (b) | O—C—O asymmetric |
| | | | stretching (CO₃²⁻) |
| 1193 (sh) | Same intensity as (a) | Peak shifts to 1000 (s, b) | Si—O—Si or |
| 1122 (s)(br) | | with 1122 (sh) | asymmetric Si—O—Si |
| | | | or Al—O—Si |
| 900 (s) | Same intensity as (a) | Becomes sh to peak | Al—O, Si—O stretching |
| | | centered around 1000 | |
| 810 (w)(br) | Same intensity as (a) | Decrease intensity | Al—O bending mode |
| | | compared to (b) | of AlO₄ |
| 722-540 (w) | Increase intensity | Peak emerges at 560, | Various Si—O—Si |
| | compared to (a) | decrease intensity | vibrations, with 560 |
| | | 722-540 | an external linkage of |
| | | | Si—O₄ or Al—O₄ |
| 480 (s, br) | Same intensity as (a) | Decrease intensity | Bending (Si—O—Si and |
| | | compared to (b) | O—Si—O) |

The analysis of the FTIR from PEG-derived systems indicates that, for a given processing condition, the material has similar vibrational energy, regardless of pH and I/O. However, key differences in the extent of geopolymer network formation (Si—O—Al) exist when compared to PVA-derived products. In the uncalcined state, vibrational energy bands for all samples are observed at relatively the same peak location and peak intensity (FIG. 4). Key vibrational bands for PEG-derived products throughout the reaction are listed in Table 3. Upon calcination at 900° C., the resulting vibrational energies of the synthetic aluminosilicate powders show (1) a decrease of O—H, C—O, and C—H bond vibrational stretching (3500-3000 cm⁻¹, 2925 cm⁻¹, 2850 cm⁻¹, 2885 cm ⁻¹, 1630 cm⁻¹ and 1380 cm⁻¹); (2) changes in Si—O—Si asymmetric bond stretching peak (1115cm⁻¹ and 1240 cm⁻¹); and moreover, (3) presence of Al—O and Si—O—Si bonds (900 cm⁻¹, 940 cm⁻¹, 840-515 cm⁻¹ and 480 cm⁻¹). Upon alkali activation, there are a number of key differences of vibrational energy band location and intensity, in particular, (1) the emergence of O—C—O and O—H vibrations due to carbonation and hydration of the cementitious material (1450 cm⁻¹ and 1380 cm⁻¹); (2) partial reactivity as observed by remaining Si—O—Si vibrations (720 cm⁻¹), which is within the broad distribution of weak resonances seen in the uncalcined synthetic aluminosilicate precursors and synthetic aluminosilicate powders from 840-515 cm⁻¹; and (3) aluminosilicate network formation (Si—O—Al) signified by a shift toward a new peak centered around 1060 cm⁻¹ with shoulders at approximately 1120 cm⁻¹ and 900 cm⁻¹. As noted for PVA products, these two shoulder locations are consistent with two main peaks in the synthetic precursors (both uncalcined and calcined). However, in the herein PEG samples, the observed Si—O—Al absorption peaks at 1060 cm⁻¹ are broad with larger shoulder regions at 1120 cm−1 and 950 cm−1. Thus indicating a variable and lower extent of Si—O—Al polymerization following alkali activation.

TABLE 3
Analysis of infrared vibrational bands in PEG derived products,
(br) broad, (s) sharp, weak (w), and (sh) shoulder.

| (a) Uncalcined | (b) Calcined | (c) Geopolymer | |
|---|---|---|---|
| Precursor (cm⁻¹) | Precursor (cm⁻¹) | Cement (cm⁻¹) | Assignment |
| 3500-3000 (br) | Decrease intensity | Increase intensity | O—H vibrational |
| | compared to (a) | compared to (b) | stretching |
| 2925 (w) | Decrease intensity | Decrease intensity | C—H asymmetric and |
| 2885 (sh) | compared to (a) | compared to (a) (b) | symmetric stretching |
| 1720 (w)(sh) | Decrease intensity | Same intensity as (b) | C—O stretching and |
| 1630 (w) | compared to (a) | | O—H stretching |
| 1450 (sh) | Decrease intensity | Same intensity as (b) | N—O stretching or |
| 1380 (s)(br) | compared to (a) | | O—C—O asymmetric |
| | | | stretching (CO₃²⁻) |
| 1240 (sh) | Same intensity as (a) | Peak shifts to 1060 (s,b) | Si—O—Si or asymmetric |
| 1115 (s)(br) | | with 1122 (sh) | Si—O—Si or Al—O—Si |
| 900 (s) | Same intensity as (a) | Becomes (sh) to peak | Al—O, Si—O stretching |
| 940 (sh) | | centered around 1000 | |
| 810 (w)(br) | Same intensity as (a) | Decrease intensity | Al—O bending mode |
| | | compared to (b) | of AlO₄ |
| 722-540 (w) | Increase intensity | Peak emerges at 720, | Various Si—O—Si |
| | compared to (a) | decrease intensity 722- | vibrations, with 560 |
| | | 540 | an external linkage of |
| | | | Si—O₄ or Al—O₄ |
| 480 (s, br) | Same intensity as (a) | Decrease intensity | Bending (Si—O—Si and |
| | | compared to (b) | O—Si—O) |

### ²⁹Si MAS-NMR and ¹H—²⁹Si CP MAS-NMR of Aluminosilicate Powders and Geopolymer Cements

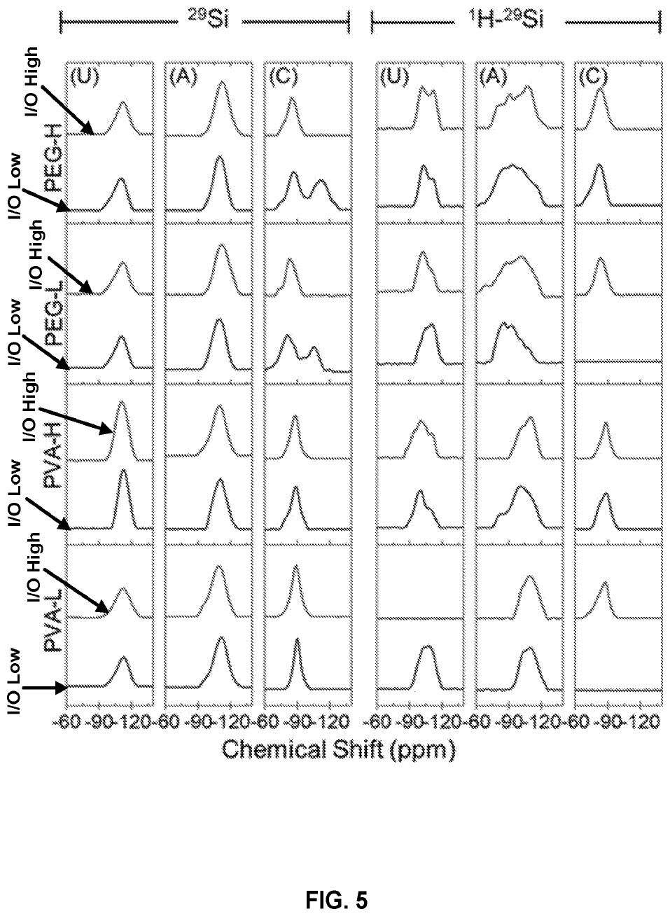

²⁹Si DP MAS-NMR technique (Bloch Decay) was used to study the silicon atomic structure of synthetic aluminosilicate materials. FIG. 5 presents the acquired ²⁹Si spectra for both uncalcined aluminosilicate precursors and synthetic aluminosilicate powders. The collected spectra reveal the predominance of resonances at chemical shifts of −112±0.87 ppm and −111±1.59 ppm assigned to Q⁴ Si environments in uncalcined and calcined powders, respectively. As a result, calcination revealed no changes to silicon atomic environments. After alkali-activation, all geopolymer cements indicate a downfield shift in ²⁹Si signal between −84 and −90 ppm assigned to Q⁴ (4Al) atomic environments in the cementitious network. PEG-derived geopolymer cements exhibited an additional resonance at chemical shift of −107 ppm corresponding to remaining Q⁴ from unreacted aluminosilicate powder when synthesized at low I/O ratios, as illustrated in FIG. 5.

Several other key differences exist between both synthesized geopolymer cements. For example, the average chemical shift in PEG-derived geopolymer cements (−83.67 ppm) was downfield-shifted to a greater extent than that of PVA-derived geopolymer cements (−89.01 ppm). Moreover, when compared to all geopolymer cements, PVA-L samples at low I/O ratio demonstrate a narrow linewidth (4.78 ppm) and further upfield shift (−89.95 ppm).

¹H—²⁹Si CP MAS-NMR experiments were conducted to study the presence of nearby hydrogen atoms to silicon nuclei. In general, PVA-derived and PEG-derived synthetic aluminosilicate precursors, as well as aluminosilicate powders, demonstrated a ²⁹Si resonance of −105±5 ppm in ²⁹Si CP MAS-NMR spectra, as expected, since cross-polarization techniques allow the resonances only from outer surface of the Al—O—Si network, which are near protons. Because of the inhomogeneous surface structure and nearby hydroxyl group, the peaks are downshifted in comparison to the bulk structure (−110 ppm vs −105 ppm). This downshift is more prominent in PEG-derived aluminosilicate powders as they exhibit ¹H—²⁹Si resonances between −100 ppm and −97 ppm, confirming the presence of single hydroxyl containing silica species (Q³). These differences may be explained by the fact that PEG-derived aluminosilicate powders at high polymer contents (low I/O ratio) do not undergo complete dehydroxylation and, thus, remnant single hydroxyls exist (Q³). Furthermore, adjacent water molecules may aid in the deshielding of Si atoms as evidenced by ²⁹Si NMR spectra (FIG. 5). Similar deshielding has been reported for Halloysite clays as interlayer water hydrogen bonds to the tetrahedral silicate layers and results in a deshielding of the ²⁹Si resonance. Unexpectedly, no ¹H—²⁹Si resonance was observed for PVA-L (high I/O) synthetic aluminosilicate precursors, which indicates the absence of near protons to effectively cross-polarize Si.

### ²⁷Al MAS-NMR and ¹H—²⁷Al CP MAS-NMR of Aluminosilicate Powders and Geopolymer Cements

²⁷Al MAS-NMR experiments were conducted to study the changes in aluminum atomic structure of synthetic aluminosilicate materials. All ²⁷Al MAS-NMR spectra of uncalcined synthetic aluminosilicate precursors (PEG and PVA derived) show resonances at 0 ppm, confirming the presence of aluminum nitrate species (i.e., Al(VI)), which was added to prepare these precursors. Synthetic aluminosilicate powders demonstrated a peak at 8 ppm, indicating the presence of similar aluminum species with minimal environment differences (FIG. 3). However, after alkali-activation, all samples exhibit resonances at both ˜60 ppm and ˜8 ppm, confirming two different atomic environments for the aluminum; one for the unreacted aluminum species Al(VI) and the reacted Al(IV) species, composing the aluminosilicate cementitious network.

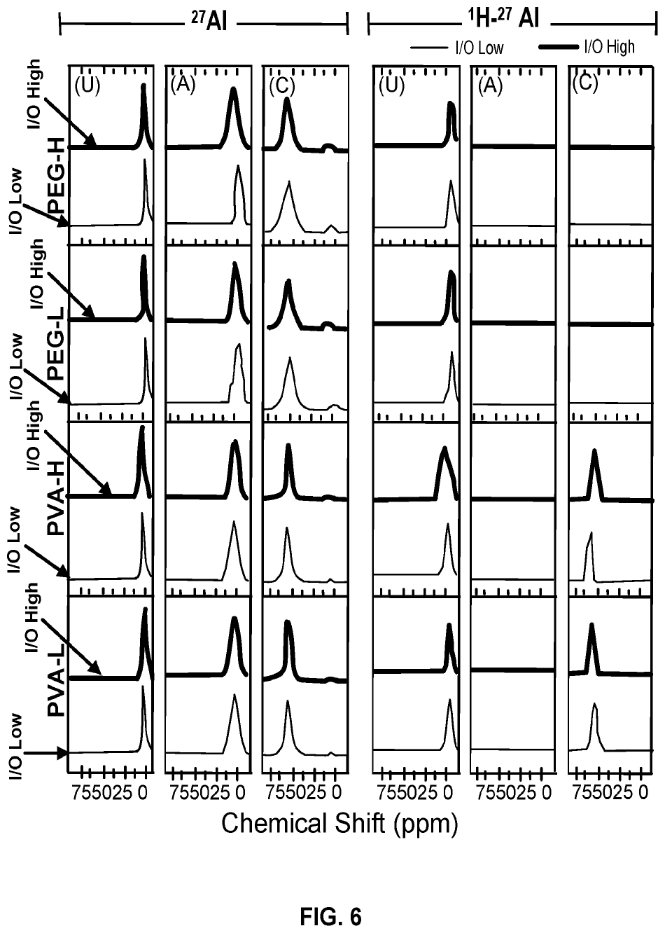

Similarly, ¹H—²⁹Al CP-MAS NMR spectra of all uncalcined synthetic aluminosilicate precursors derived from PEG, as well as PVA, showed resonance near 0 ppm, indicating the presence of Al(VI) species. However, no ¹H—²⁹Al CP MAS-NMR signal was observed for all calcined synthetic aluminosilicate powders or geopolymer cements, regardless of polymer crosslinker used (FIG. 6).

Hence, suggesting that Al(VI) species were incorporated in the network with oxygen, but they were very far from the nearby protons of water or hydroxyls. This observation suggests that water molecules were evaporated due to high temperature of calcination process, and polymers were volatilized from the Al—Si network in these calcined precursors, as expected from FTIR results. Similar results for geopolymers indicate the presence of Al(IV) species coordinated with SiO₄ in a network with segregated Al(VI) phases as seen in the XRD data (FIG. 3) with far protons unsuccessful to transfer nuclei polarization.

### Effect of Polymer Architecture (PEG vs. PVA)

Differences in polymer architecture, more specifically, the absence of hydroxyls (i.e., PVA) and presence of ethers (i.e., PEG), result in phase segregation within the xerogel and, as a result, form γ-alumina in the synthetic aluminosilicate powder, as confirmed by XRD (FIG. 3) and ²⁷Al MAS-NMR (FIG. 6, Table 4). Moreover, ²⁷Al MAS-NMR of these PEG-derived aluminosilicate powders (FIG. 6) demonstrates that mainly Al(VI) sites exist, as evidenced by the presence of a resonance peak at ˜5-9 ppm (Table 4). This finding is seemingly contradictory to the often reported defective spinel structure of γ-alumina. However, a decrease in the tetragonal nature of γ-alumina has been observed with increasing temperatures >700° C. and adsorption of gases at high temperatures, and may be similar to the ‘γ-alumina, an anhydrous alumina form as verified by the absence of resonance on ²⁷Al—¹H MAS-NMR spectra (FIG. 6, Table 4). Moreover, contradictory to recent studies, the inventors found no evidence of Al(IV) or Al(V) for PVA-L synthetic aluminosilicate powders synthetized at low-I/O ratios (i.e., high polymer contents). This difference is likely due to the redefinition of the I/O ratio, as explained above.

TABLE 4
Atomic environment assignments of ²⁷Al MAS-NMR and ¹H-²⁷Al MAS-NMR spectra for (a)
uncalcined precursors, (b) calcined precursors, and (c) geopolymer cements.
Assignments are based on Rohner et al. (1989).

| | | (a) Uncalcined Precursor | | | | (b) Calcined Precursor | | | | (c) Geopolymer Cement | | | |
|---|---|---|---|---|---|---|---|---|---|---|---|---|---|
| | I/O | ²⁷Al δ | | ²⁷Al-¹H δ | | ²⁷Al δ | | ²⁷Al-¹H δ | | ²⁷Al δ | | ²⁷Al-¹H δ | |
| Sample | Ratio | (ppm) | Al | (ppm) | Al | (ppm) | Al | (ppm) | Al | (ppm) | Al | (ppm) | Al |
| PVA-L | Low | 0.53 | Al(VI) | 0.53 | Al(VI) | 8.53 | Al(VI) | — | — | 59.29 | Al(IV) | 59.68 | Al(IV) |
| | | | | | | | | | | 8.49 | Al(VI) | | |
| | High | 0.13 | Al(VI) | 0.13 | Al(VI) | 8.09 | Al(VI) | — | — | 59.17 | Al(IV) | 61.54 | Al(IV) |
| | | | | | | | | | | 8.5 | Al(VI) | | |
| PVA-H | Low | 0.61 | Al(VI) | 0.61 | Al(VI) | 7.62 | Al(VI) | — | — | 59.67 | Al(IV) | 60.2 | Al(IV) |
| | | | | | | | | | | 9.01 | Al(VI) | | |
| | High | 1.97 | Al(VI) | 1.97 | Al(VI) | 7.39 | Al(VI) | — | — | 59.04 | Al(IV) | 58.97 | Al(IV) |
| | | | | | | | | | | 8.18 | Al(VI) | | |
| PEG-L | Low | 0 | Al(VI) | 0 | Al(VI) | 6.94 | Al(VI) | — | — | 60.16 | Al(IV) | — | — |
| | | | | | | | | | | 7.14 | Al(VI) | | |
| | High | 0.15 | Al(VI) | 0.15 | Al(VI) | 9.26 | Al(VI) | — | — | 60.55 | Al(IV) | — | — |
| | | | | | | | | | | 6.26 | Al(VI) | | |
| PEG-H | Low | 0.1 | Al(VI) | 0.1 | Al(VI) | 5.35 | Al(VI) | — | — | 61.68 | Al(IV) | — | — |
| | | | | | | | | | | 10.48 | Al(VI) | | |
| | High | 0.31 | Al(VI) | 0.31 | Al(VI) | 9.18 | Al(VI) | — | — | 59.88 | Al(IV) | — | — |
| | | | | | | | | | | 6.95 | Al(VI) | | |

Limited silicate incorporation into the gel 1→gel 2 evolution process within PEG-derived geopolymer cements may occur as observed by a higher ²⁹Si NMR deshielding and higher variability of Si polymerization in FTIR results, when compared to PVA-derived samples as indicated in Table 2, Table 3 and Table 5. The gel 1 has been described as an initial Al-rich binder with a high content of Si—O—Al bonds relative to the bulk Si:Al ratio. This initial gel 1 is said to structurally evolve via condensation of silanols and incorporation of silicon metals, hence increasing the effective Si:Al ratio of the binder. The ²⁹Si NMR resonances of PEG-derived geopolymer cements are downfield shifted between −80 ppm and −85 ppm, when compared to PVA-derived geopolymer cements as seen in Table 3. Deshielding of the ²⁹Si nuclei may be due to next-nearest neighbor (Al) or structural distortions of the gel 2, which are hypothesized to be caused by limited silicate incorporation in the gel 1 precursor. Further confirming these results, FTIR results for PEG-derived geopolymer cements demonstrate geopolymer network formation as observed by peak shifts to lower wavenumbers corresponding to formation of Si—O—Si and Si—O—Al bonds (1120 cm⁻¹→1060 cm⁻¹), Table 3. Contrastingly, PVA-derived geopolymer cements exhibit greater extent of silicate incorporation in the gel 1→gel 2 evolution process as sharp and intense absorption peaks are observed to be centered around 1000 cm⁻¹.

TABLE 5
Atomic environment assignments of ²⁹Si MAS-NMR and ¹H-²⁹Si MAS-NMR spectra for (a)
uncalcined precursors, (b) calcined precursors, and (c) geopolymer cements.
Assignments are based on Rohner et al. (2003) and Provis et al. (2012).

| | | (a) Uncalcined | | | | (b) Calcined | | | | (c) Geopolymer | | | |
|---|---|---|---|---|---|---|---|---|---|---|---|---|---|
| | | Precursor | | | | Precursor | | | | Cement | | | |
| | I/O | ²⁹Si δ | | ²⁹Si-¹H δ | | ²⁹Si δ | | ²⁹Si-¹H δ | | ²⁹Si δ | | ²⁹Si-¹H δ | |
| Sample | Ratio | (ppm) | Q [symbol] | (ppm) | Q [symbol] | (ppm) | Q [symbol] | (ppm) | Q [symbol] | (ppm) | Q [symbol] | (ppm) | Q [symbol] |
| PVA-L | Low | −110.87 | Q [symbol] | −106.8 | Q [symbol] | −111.38 | Q [symbol] | −110.3 | Q [symbol] | −89.95 | Q [symbol] (4A1) | — | — |
| | High | −111.91 | Q [symbol] | — | — | −111.2 | Q [symbol] | −108.02 | Q [symbol] | −88.88 | Q [symbol] (4A1) | −87.5 | Q [symbol] |
| PVA-H | Low | −112.52 | Q [symbol] | −103.6 | Q [symbol] | −109.42 | Q [symbol] | −106.8 | Q [symbol] | −89.34 | Q [symbol] (4A1) | −88.33 | Q [symbol] |
| | High | −110.95 | Q [symbol] | −111 | Q [symbol] | −109.6 | Q [symbol] | −110.37 | Q [symbol] | −87.86 | Q [symbol] (4A1) | −88.14 | Q [symbol] |
| PEG-L | Low | −110.69 | Q [symbol] | −111.8 | Q [symbol] | −109.09 | Q [symbol] | −100 | Q [symbol] | −85.06 | Q [symbol] (4A1) | — | — |
| | | | | | | | | | | −108.55 | Q [symbol] | | |
| | High | −113.16 | Q [symbol] | −102.4 | Q [symbol] | −113.28 | Q [symbol] | −105.8 | Q [symbol] | −80.4 | Q [symbol] (4A1) | −83.52 | Q [symbol] |
| PEG-H | Low | −111.82 | Q [symbol] | −101.8 | Q [symbol] | −109.02 | Q [symbol] | −97 | Q [symbol] | −83.94 | Q [symbol] (4A1) | −84.07 | Q [symbol] |
| | | | | | | | | | | −107.04 | Q [symbol] | | |
| | High | −111.2 | Q [symbol] | −107.4 | Q [symbol] | −112.15 | Q [symbol] | −109.3 | Q [symbol] | −85.26 | Q [symbol] (4A1) | −83.52 | Q [symbol] |

[symbol]

indicates data missing or illegible when filed

### Effect of Polymer Content (I/O ratio: Low vs. High)

Decreasing the polymer content (high I/O ratio) reduces Al metal-polymer coordination and results in partial γ-alumina formation for PEG-derived aluminosilicate powders (see FIG. 3). As a result of the decreased polymer-metal coordination, the aluminosilicate powder produced is considered to be of higher reactivity as evidenced by the absence of unreacted Q⁴ as presented in FIG. 5. The geopolymer cements resemble PVA-derived geopolymer cements with Q⁴(4Al) atomic sites. Contrastingly, increasing the polymer content (low I/O) produces geopolymer cements with partial reactivity as evidenced by the presence of Q⁴ and Q⁴(4Al) silicon sites. At such high polymer contents, incomplete dihydroxylation is also observed in the aluminosilicate powders by the presence of single silanols (Q³) or adjacent water, see Table 5. Similar deshielding has been reported for Halloysite clays. These results are important, as polymer content is evidenced to affect Si—Al atomic coordination. Contrastingly to prior work, no presence of Al(IV) or distorted Al(VI) sites has been observed for similar aluminosilicate powders.

### Effect of Sol-Gel Aging Conditions (pH: Low vs. High)

There are minimal differences in aluminosilicate powders synthetized with low or high pH sol-gel aging conditions, indicating that the order of chemical addition bears little effect on the synthesis procedure. For example, PVA-H aluminosilicate powders have slightly higher deshielding of their ²⁹Si nuclei, as seen in Table 5. Moreover, when compared to samples synthesized with high PVA polymer contents, samples synthesized with a high pH sol-gel aging condition and low PVA polymer contents have a reduction in the absorption peak intensities associated with Si—O—Si and Si—O—Al bonds at ˜1060 407 cm⁻¹.

However, when alkali-activated, synthetic aluminosilicate powders produced with low pH sol-gel aging conditions may improve the extent of geopolymerization and dictate the content of silanol groups in the resultant geopolymer cement. PEG-derived geopolymer cements synthesized with low pH sol-gel aging conditions exhibit higher absorption intensities for Si—O—Si and Si—O—Al bonds, when compared to PEG samples produced in high pH conditions (FIG. 4). High absorption intensity may indicate a greater extent of silicate incorporation and content of Q⁴(4Al) units in the geopolymer cements, as previously discussed. Additionally, low pH sol-gel aging conditions yield geopolymer cements with no evidence of geminal silanol groups, regardless of polymer used during synthesis. As seen in FIG. 5 and indicated in Table 5, no resonance peak is observed for ¹H—²⁹Si cross-polarized signal of both PVA-L and PEG-L synthesized with high polymer contents. This result is likely a consequence of the absence of “near protons” and presence of labile water species (indicated by high intensity —OH vibrational stretching, see FIG. 4, Table 2, and Table 3), which are not near enough for cross-polarization of ²⁹Si nuclei. Moreover, the absence of silanol groups has been described and explained and it is indicative of well-formed geopolymer binders with the majority of framework sites being Q⁴. Lastly, “traditional” chemical compositions of metakaolin-based geopolymer cements have been reported to exhibit residual silanols from unreacted metakaolin particles, as well as geminal and vicinal silanol groups.

### Natural Analogue of Synthetic Aluminosilicates: Metakaolin

All synthesized aluminosilicate precursors approximate the chemical composition of calcined clays (i.e., metakaolin) as evidenced by FIG. 2. Moreover, similarities to metakaolin are evidenced in both the ²⁹Si and ²⁷Al MAS-NMR with resonances near −110 ppm and ˜10 ppm corresponding to Q⁴ Si units and Al(VI), respectively (Table 4 and Table 5). In addition, the presence of silanol groups in PEG-derived synthetic aluminosilicate powders at low I/O ratios is similar to reported residual silanol groups in metakaolin. Thus, the atomic structure of synthetic aluminosilicate powders may resemble a homogenous mix of Q⁴ Si units and Al(VI) units with residual silanol groups in particular cases. However, the structure of synthetic aluminosilicate precursors differs from that of metakaolin due to the absence of Q³ sheet-like Si layers, Al(IV), Al(V), or segregated amorphous alumina phases. In general, metakaolin possesses a broad ²⁹Si MAS-NMR resonance peak at −103 ppm with a linewidth of ca. 20 ppm, assigned to Q³ ‘sheet-like’ layers, as well as ²⁹Si resonances corresponding to Q⁴(1Al) silicon center. Contrastingly, synthesized aluminosilicate powders possess ²⁹Si MAS-NMR resonance peak at −111 ppm, which does not indicate any aluminum bond with silicon. Furthermore, no presence of Al(IV), Al(V), or regions of segregated amorphous alumina are observed in synthesized aluminosilicate powders, as characteristic of the atomic structure of metakaolin.

TABLE 6
NMR peaks detected by various studies
on (C)—N—A—S—H cementitious
binder variants.

| Geopolymer Cement | ²⁹Si NMR (ppm) | ²⁷Al NMR (ppm) |
|---|---|---|
| Na₀₆₂₅Si_{1.00}Al_{0.625}•xH₂O | −89.0 | 58.0 |
| Ca_{0.800}Na_{0.078}Si_{1.00}Al_{0.156}•xH₂O | −75.0, −79.0, −84.0, | 57.0, 0.0 |
| | −86.0, −89.0, −94.0 | |
| Na_{1.00}Si_{1.08}Al_{1.00}•xH₂O | −86.5, −89.0* | 57.4 |
| Na_{1.18}Si_{1.5}Al_{1.00}•xH₂O | — | 61.5, 8.8 |
| Na_{~0.015}Si_{1.00}Al_{1.00}•xH₂O | −87.0, −103.0 | 78.0 |

*Presence of Zeolite A found in samples.

The presence of extra-framework aluminum (EFAl) was reported in 2012 for metakaolin-based geopolymer cements with Si:Al and Na:Al atomic ratios of 1.6 and 1.0, respectively. The observed structural stability of these cements was attributed to the presence of these tetrahedrally coordinated aluminum ions (i.e., Al(IV)). More recently, EFAl with an Al(IV) resonance have been observed in geopolymer cements with Si:Al and Na:Al atomic ratios of 1.50 and 1.18, respectively.

Contrastingly, in the present examples, ²⁷Al—¹H NMR detected the presence of Al(IV) resonances at 60.5±1.5 ppm for PVA-derived geopolymer cements solely, which is in good agreement with results collected from the literature (Table 6). These cross-polarized nuclei resonances have been attributed in other studies to bridging hydroxyl groups (Si—OH⁺—Al, Brønsted-acid sites). Presence of these hydroxyl groups, both in Si and Al nuclei, have been shown to hydrogen bond with structural water molecules, resulting in the elongation of Al—O bonds. An important observation for the stability and durability of these cements.

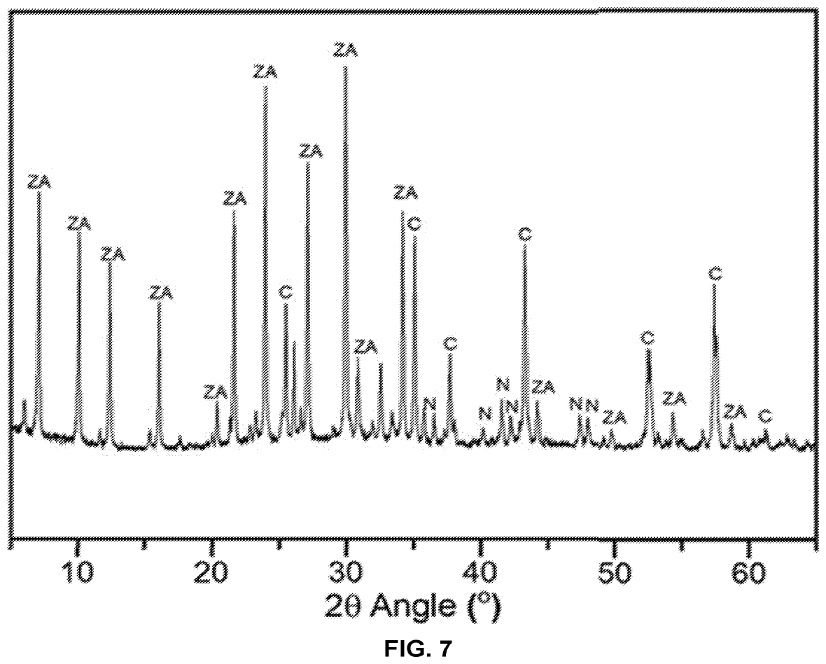

Similar to studies of alkali-activated metakaolin, PEG-derived geopolymer cements have resonances at −107 ppm (Q⁴) from unreacted synthetic aluminosilicate powder (−103 ppm, attributed to Q³ Si-sheets, in metakaolin) and −85 ppm, indicative of Q⁴(4Al) aluminosilicate (FIG. 5 and Table 5). Similar resonances have been detected in N-A-S-H binder variants, as seen in Table 6. Contrastingly, all PVA-derived geopolymer cements indicate the presence of solely Q⁴(4Al) aluminosilicate (FIG. 5 and Table 5), characteristic of N-A-S-H binders of low Si:Al ratios, these also resemble the mineralogy of metakaolin-based cements (FIG. 7). In addition, peaks at 800 cm⁻¹ are assigned to Al—O stretching in Al(VI) decrease in intensity or are not visible following alkali-activation, suggesting that the octahedral structure breaks down with geopolymerization.

### Mechanisms of the Polymer-Assisted Sol-Gel Synthesis

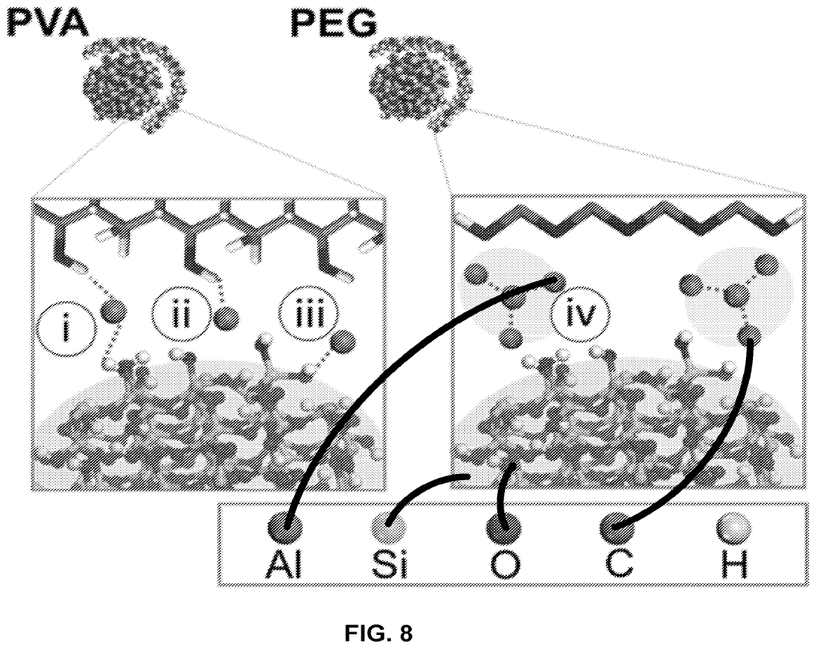

Data collected suggest three possible mechanisms by which the polymer-assisted sol-gel synthesis permits the incorporation of solubilized aluminum ions (Al⁺³). As depicted in FIG. 8, Al⁺³ incorporation may be possible by: (1) complexation with polymer cross-linker, (2) hydrogen bonding with silanol, and (3) competition between these two complexation mechanisms. These will be discussed in the following sections.

### Polymer Cross-Linker Complexation of Al⁺³ Metal Ions

Architecture differences in polymer cross-linker oxide (i.e., ether, hydroxyl) may influence the polymer-metal interactions of Al⁺³ ions by inducing metal complexation or hydrogen bonding. Given that oxygen is a strong electron donor in both PVA and PEG systems, the electron-poor aluminum metal would tend to associate with these atoms to form complexes. Evidence for such metal-polymer complexes is observed for PVA-derived uncalcined synthetic aluminosilicate precursors, indicated by a shift of a vibrational peak centered around 1750 cm⁻¹ in reagent PVA to 1730 cm⁻¹ after polymer assisted sol-gel synthesis. The shift of this peak may indicate polymer-metal interactions between residual carbonyl groups on PVA polymer cross-linkers (an artifact from commercial fabrication of PVA from poly(vinyl acetate)) and the aluminum metal (at 1730 cm⁻¹) (FIG. 4). Changes in vibrational energy toward lower wavenumbers following interactions with metals have previously been attributed to metal-ion complexation with the carbonyl (C—O) moiety in PVA.

For PEG-derived uncalcined synthetic aluminosilicate precursors, previous literature suggests that Al⁺³ polymer coordination occurs in the C—O—C stretching region between 1110-1105 cm⁻¹. For this system, the 1100 cm⁻¹ region corresponds to Si—O—Si vibrational stretching and bending frequencies, thus hindering the analysis of metal-polymer coordination for PEG-based systems. For both polymeric systems, it can be speculated that the hydration of components by water during the sol-gel aging would enable hydrogen bonding between water and pendant hydroxyl units, and, as the xerogels develop (i.e., dehydration), metal coordination may be enhanced, as with less volume the materials are more likely to interact. For both PEG and PVA systems, following calcination, the vibrational bands at 1730 cm⁻¹, as well as broad vibrational bands from 3500-3000 cm⁻¹ corresponding to O—H stretching frequency in both PVA and PEG-derived synthetic aluminosilicate powders, decrease in intensity. This decrease in intensity may indicate that the polymer, nitrate counter ion, and water were effectively removed following calcination, likely disrupting the Al⁺³ polymer coordination. Such disruptions may explain the absence of Al(IV) and distorted Al(VI) sites in the aluminosilicate powder, contrary to published literature.

### Silanol Coordination of Al⁺³ Metal Ions

²⁹Si MAS-NMR (FIG. 5 and Table 5) does not reveal bulk aluminum incorporation in the xerogels of the uncalcined synthetic aluminosilicate precursor; however, cross-polarization data on these gels suggest the possibility of coordination and sparse hydrogen bonding between silanol and aluminum ions in certain synthesis conditions. However, determination of different Q⁴(nAl) sites may be determined based on peak maxima with linewidths of 10 ppm, as described in ²⁹Si MAS-NMR spectra collected herein demonstrates the single-phase purity of precursors, due to narrower linewidths than reported in literature and high upfield resonances. As seen in Table 5, uncalcined synthetic aluminosilicate precursors demonstrate peak resonances at −111 ppm that are attributed to Q⁴ silicon sites.

Furthermore, narrow linewidths between 8.3 ppm and 17.4 ppm (FIG. 5) render the determination of different Q⁴(nAl) sites inappropriate, as aforementioned, and no FTIR evidence specifically supports the presence of corresponding Si—O—Al bonds in uncalcined synthetic aluminosilicate precursors, even though vibrational frequency corresponding to Si—O—Si asymmetric stretching is observed (FIG. 4, Table 2 and Table 3). However, ²⁹Si CP/MAS NMR signal provides spectra of nuclei spatially close to immobilized hydroxyls, structural water molecules, or other protonated species, typically less than 5 A°. As observed in Table 4, all uncalcined synthetic aluminosilicate precursors exhibit cross polarization resonances which provide further evidence of Q⁴ silicon atomic sites interacting with hydrous species, possibly from the water-shell associated with Al⁺³ cations (i.e., Al(VI)). In addition, presence of single silanol groups (Q³, −100 ppm) remaining in PEG-derived samples aged at high pH values and low I/O suggest the possibility for hydrogen bonding between silica particles and Al⁺³ cations.

FTIR can be used to suggest mechanisms of inter- and intra-molecular coordination, such as hydrogen bonding in the xerogel. For both polymer architectures in the xerogel, the vibrational peak at 1650 cm⁻¹ is attributed to H—O—H bending vibrations and is present in the FTIR of silica, aluminum nitrate, and PVA starting materials but at a lesser intensity than in the xerogel. The peak centered at 1650 cm⁻¹ in conjunction with the broad stretching vibration of —OH centered at approximately 3400 cm⁻¹ is often attributed to hydrogen bonding or water adsorption. For all xerogel materials, there is an increase in the intensity of these two vibrational frequencies. The increase in intensity may be attributed to hydrogen bonding between hydroxyl units between the polymers, silica, and bound water or to coordination of the silanol to aluminum following xerogel formation (FIG. 8). The changes in these molecular vibrations do not specifically indicate that silanol is coordinating with aluminum oxide, but can suggest this mechanism along with other hydrogen bonding mechanisms.

Contrary to previous publications, the presence of Al(IV) or distorted Al(VI) was not observed, likely due to differences in the polymer content (i.e., I/O ratio). As explained above, based on previous literature, it is known that Al⁺³ metal-polymer coordination occurs in the C—O—C stretching region between 1110-1105 cm⁻¹. Consequently, polymer cross-linker complexation of Al⁺³ metal ions is expected to be the dominant mechanism for producing high-reactivity aluminosilicate powders, hence explaining the differences of results observed.

This disclosure described the effects of polymer architecture (i.e., PVA vs. PEG), polymer content (i.e., low vs. high ion-to-polymer-oxide (I/O) atomic ratio), and sol-gel aging pH conditions (i.e., low vs. high) on the atomic structure of resultant synthetic aluminosilicate powders and geopolymer cements.

Results have shown that polymer architecture is a primary factor in controlling phase segregation in synthetic aluminosilicate powders and the resulting mineralogy of geopolymer cements. The use of FTIR, XRD, and ²⁹Si and ²⁷Al single pulse and ¹H cross-polarized MAS-NMR confirmed the effect of polymer architecture on the metal complexation of Al⁺³ ions, while PEG polymers yielded phase segregation during synthesis and formation of γ-alumina with a predominance of Al(VI) sites. Contrastingly, it is observed that the presence of hydroxyls in PVA may provide higher ion coordination competition, which results in synthetic aluminosilicate powders and geopolymer cements with single atomic environments. Moreover, PEG-derived synthetic aluminosilicate powders are most similar to the atomic environment of metakaolin (i.e., calcined clay).

A decrease of polymer content during synthesis is observed to improve reactivity of the precursor, improving the extent of binder formation in these samples, while sol-gel pH aging conditions (affected by order of reactant addition) reveals the ability to influence the content of Brønsted-acid sites (—OH groups) near the aluminum nuclei and geminal silanol groups within geopolymer cements. As a result, the molecular structure and mineralogy of resultant geopolymer cements is affected in the following order of significance: polymer type>polymer content>sol-gel pH aging condition. Finally, metakaolin-based geopolymers resemble the molecular structure and mineralogy of PVA-derived geopolymer cements. Thus, validating the further use of metakaolin as an aluminosilicate precursor to produce highly pure N-A-S-H cementitious binders.

Evidence collected supports three possible mechanisms by which the polymer-assisted sol-gel synthesis permits the incorporation of solubilized aluminum ions (Al⁺³) and formation of N-A-S-H (sodium-aluminum-silicate-hydrate) geopolymer binders. The proposed mechanisms are hypothesized to be related to: (1) complexation with polymer cross-linker, (2) hydrogen bonding with silanol, and (3) competition between polymer cross-linker coordination and silanol-based poly-condensation. It is expected that Al⁺³ metal-polymer competition dominates the mechanism for the production of high reactivity aluminosilicate powders.

The example embodiments of the disclosure described above do not limit the scope of the invention, since these embodiments are merely examples of the embodiments of the invention. Any equivalent embodiments are intended to be within the scope of this invention. Indeed, various modifications of the disclosure, in addition to the embodiments shown and described herein, such as alternative useful combinations of the elements described, may become apparent to those skilled in the art from the description. Such modifications and embodiments are also intended to fall within the scope of the appended claims.

1. A method of forming aluminosilicate material, the method comprising the steps of:
forming a polymer solution;
adding an aluminum precursor to the polymer solution;
adding a silicon precursor to the polymer solution;
forming a gel from the polymer solution;
calcining the gel to form an aluminosilicate powder; and
grinding the aluminosilicate powder to form ground aluminosilicate material.

2. The method of claim 1, wherein the step of forming a polymer solution comprises dissolving PEG in water.

3. The method of claim 2, wherein the step of forming a polymer solution comprises dissolving greater than 0% to about 25%, about 0.1% to about 10%, or about 1% to about 5% PEG in the water.

4. The method of claim 1, wherein the step of forming a polymer solution comprises dissolving PVA in water.

5. The method of claim 4, wherein the step of forming a polymer solution comprises dissolving greater than 0% to about 25%, about 0.1% to about 10%, or about 1% to about 5% PVA in the water.

6. The method of claim 1, wherein a pH of the polymer solution is about 1 to about 14, or about 1 to about 10.

7. The method of claim 1, further comprising passing the ground aluminosilicate material through a sieve.

8. The method of claim 7, wherein the ground aluminosilicate material is passed through a 100 μm mesh sieve.

9. The method of claim 1, further comprising a step of alkali activating the ground aluminosilicate material.

10. The method of claim 9, wherein the step of alkali activating comprises adding one or more of an NaOH solution, KOH solution, NaSi solution, or Na₂CO₃ solution to the ground aluminosilicate material.

11. The method of claim 10, wherein a concentration of the NaOH solution is about 0.1M to about 15M, or about 0.1M to about 14M, or about 1M to about 10M.

12. The method of claim 1, further comprising a step of forming a cement.

13. The method of claim 1, further comprising a step of forming a paste.

14. The method of claim 1, further comprising a step of forming acid-resistant concrete.

15. The method of claim 1, further comprising adding additives to the polymer solution.

16. The method of claim 1, further comprising a step of forming a coating.

17. Concrete formed according to the method of claim 1.

18. An acid-resistant concrete formed according to the method of claim 1.
